(19) United States
(12) Patent Application Publication
(10) Pub. No.: US 2006/0289724 A1
(43) Pub. Date: Dec. 28, 2006

(54) Fiber optic sensor capable of using optical power to sense a parameter

(76) Inventors: Neal G. Skinner, Lewisville, TX (US); Harry D. Smith, Montgomery, TX (US)

Correspondence Address: Brian J. Gaffney;Baker Botts L.L.P., 2001 Ross Avenue #600, Dallas, TX, 75201-2980, US

(21) Appl. No.: 11/156,964

(22) Filed: Jun. 20, 2005

(51) Int. Cl. G06M 7/00; H01J 40/14

(52) U.S. Cl. 250/221

(57) ABSTRACT

A sensor includes an optical-to-electrical conversion device that is operable to convert at least a portion of an optical power of an optical signal received by the sensor to electrical power. The sensor also includes a sensing device that is operable to detect one or more state properties of an environment. The sensing device is also operable to generate one or more sensing signals in response to the detected state properties. The sensing device uses at least a portion of the electrical power to detect the one or more state properties. The sensor further includes an optical device that is operable to manipulate one or more optical characteristics of the optical signal based at least in part on the sensing signal. The optical device is also operable to communicate at least a portion of the manipulated optical signal from the sensor.

### TECHNICAL FIELD OF THE INVENTION

This invention relates in general to fiber optic sensors, and more particularly, to an optical sensor capable of using optical power of an optical signal to detect a parameter within a remote environment.

### OVERVIEW

Fiber optic sensors used in remote environments, such as those found “under-sea” in telecommunications systems and/or “down-hole” in oil and gas wells, operate to sense parameters within the environment and to communicate those parameters to instrumentation outside the environment. In some oil and gas applications, the environment in a down-hole well can include relatively high temperatures, high vibration, corrosive chemistries, and/or the presence of hydrogen. Because of the environment within the remote location, sensors often require certain supporting technologies, such as power and cooling, which increase the cost and decrease the reliability of the overall system. The inclusion of a sensor in down-hole equipment, therefore, imposes reliability constraints on the entire system, increases the cost of the system itself, and increases the cost of operation thereof.

### SUMMARY OF EXAMPLE EMBODIMENTS

In one embodiment, a sensor comprises one or more optical-to-electrical conversion devices that are operable to convert at least a portion of an optical power of an optical signal received by a sensor to electrical power. The sensor also comprises one or more sensing devices that are coupled to the optical-to-electrical conversion devices. The sensing devices are operable to detect one or more state properties of an environment and to generate one or more sensing signals in response to the detected state properties. The sensing devices use at least a portion of the electrical power to detect the one or more state properties. The sensor further comprises one or more optical devices that are operable to manipulate one or more optical characteristics of the optical signal based at least in part on the sensing signal and to communicate at least a portion of the manipulated optical signal from the sensor.

In another embodiment, a sensor comprises one or more optical-to-electrical conversion devices that are operable to convert at least a portion of an optical power of an optical signal received by a sensor to electrical power. The sensor also comprises one or more sensing devices that are operable to detect one or more state properties of an environment and to generate one or more sensing signals in response to the detected state properties. The sensor further comprises one or more optical devices that are coupled to at least some of the optical-to-electrical conversion devices. The one or more optical devices are operable to manipulate one or more optical characteristics of the optical signal based at least in part on the sensing signal and to communicate at least a portion of the manipulated optical signal from the sensor. At least one of the optical devices uses at least a portion of the electrical power to change a reflective property of the at least one optical device. The change in the reflective property operates to manipulate at least one of the one or more optical characteristics.

Depending on the specific features implemented, particular embodiments of the present invention may exhibit some, none, or all of the following technical advantages. Various embodiments may be capable of converting optical power to electrical power for use in sensing a parameter within a remote location. Some embodiments may be capable of converting optical power to electrical power for use in manipulating a position of a mirror in response to a sensed parameter. Other technical advantages will be readily apparent to one skilled in the art from the following FIGURES, description and claims. Moreover, while specific advantages have been enumerated, various embodiments may include all, some or none of the enumerated advantages.

### BRIEF DESCRIPTION OF THE DRAWINGS

For a more complete understanding of the present invention, and for further features and advantages thereof, reference is now made to the following description taken in conjunction with the accompanying drawings, in which:

FIG. 1 is a block diagram illustrating one example of an optical communication system capable of using the optical power of an optical signal to sense or detect a parameter at a remote location;

FIG. 2 is a block diagram of one example of a down-hole well system that implements an optical communication system capable of using the optical power of an optical signal to sense or detect a parameter at a remote location;

FIGS. 3a and 3b illustrate one example embodiment of a micro-electro-mechanical system (“MEMS”) device that includes an interferometer capable of converting optical power of an optical signal into electrical power;

FIG. 4 illustrates one example of an optical sensor 400 capable of using the optical power of an optical signal to sense or detect a parameter at a remote location;

FIG. 5 illustrates one example of an optical sensor capable of using the optical power of an optical signal to sense or detect a parameter at a remote location;

FIG. 6 illustrates one example of an optical sensor capable of using the optical power of an optical signal to sense or detect a parameter at a remote location; and

FIG. 7 is a flow chart illustrating one example embodiment of a method of using at least a portion of optical power of an optical signal to sense or detect a parameter of a remote environment.

### DETAILED DESCRIPTION OF EXAMPLE EMBODIMENTS

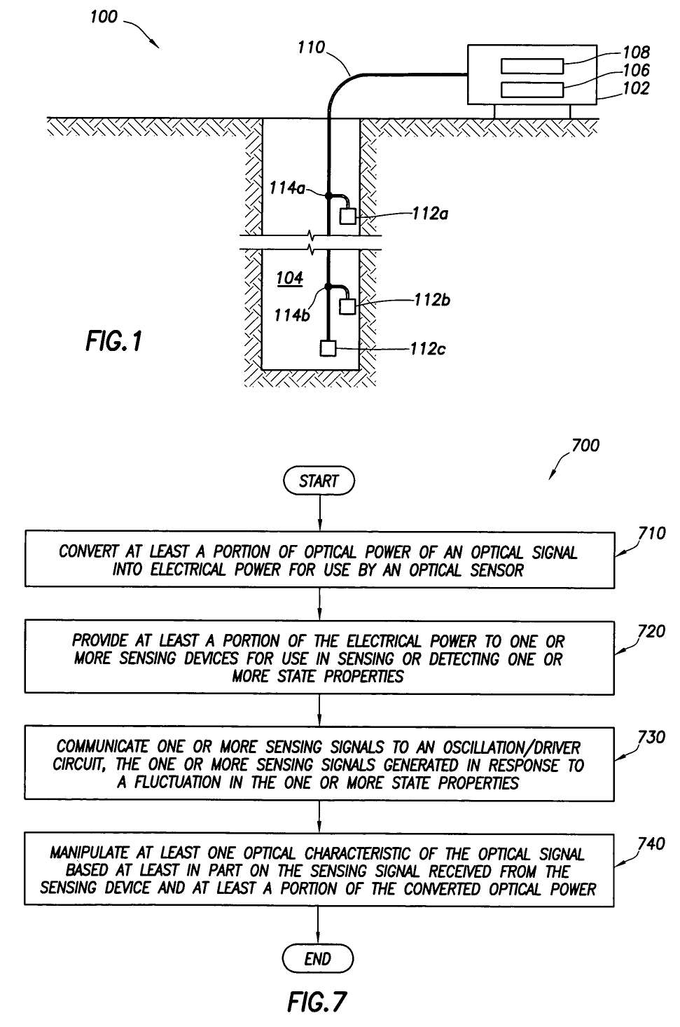

Particular examples and dimensions specified throughout this document are intended for illustrative purposes only, and are not intended to limit the scope of the present disclosure. In particular, this document is not intended to be limited to “down-hole” oil and gas applications. The teachings of the present disclosure may used in any field of endeavor where it is desired to use optical power in sensing one or parameters. Moreover, the illustrations in FIGS. 1 through 7 are not intended to be to scale.

FIG. 1 is a block diagram illustrating one example of an optical communication system 100 capable of using the optical power of an optical signal to sense or detect a parameter at a remote location. Although this example illustrates system 100 being deployed in a down-hole environment, system 100 can be used to sense or detect a parameter at any remote location without departing from the scope of the present disclosure. In this example, system 100 includes a controller 102 that is capable of monitoring one or more parameters associated with environment 104. Controller 102 can comprise, for example, any combination of hardware, software, and/or firmware that is capable of performing a desired functionality.

In the illustrated example, controller 102 includes a light source 106 capable of communicating one or more optical signals for use in sensing or detecting one or more state properties associated with environment 104. Light source 106 may comprise, for example, a solid state laser, such a Nd:YAG or Nd:YLF laser, a semiconductor laser, a laser diode, a cladding pump fiber laser, a continuum source, a light emitting diode, an incandescent light bulb, an amplified spontaneous emission, or any combination of these or other light sources. In other embodiments, the light source can reside external to controller 104.

Controller 102 also includes a processor 108 capable of analyzing one or more optical signals communicated from environment 104. In some cases, processor 108 is capable of analyzing a received optical signal and associating the received optical signal to fluctuations in one or more state properties of environment 104. In some cases, controller 102 may include one or more devices capable of performing optical-to-electrical and/or electrical-to-optical signal conversion and/or generation. In other cases, controller 102 may include other devices capable of performing any other desired functionality.

System 100 further includes one or more optical fibers 110 capable of communicating the one or more optical signals to and/or from environment 104. Optical fibers 110 can comprise, for example, a single mode optical fiber, a multi-mode optical fiber, or a combination of these or other fiber types. In one particular example, optical fibers 110 comprise 50/125 μm Graded Index Multi-Mode fibers manufactured by SUMITOMO.

In this particular embodiment, optical fibers 110 operate to couple controller 102 with one or more optical sensors 112 within environment 104. As used throughout this document, the term “couple,” “couples,” and/or “coupled” refers to any direct or indirect connection between two or more elements, whether or not those elements are in physical contact with one another. In this example, optical fiber 110 includes a first coupler 114a and a second coupler 114b each capable of demultiplexing and/or multiplexing one or more optical signals with other optical signals communicated within optical fiber 110. In some cases, each of couplers 114 can comprise a wavelength division multiplexer and/or wavelength division demultiplexer capable of coupling and/or decoupling particular one or more optical signal wavelengths or bands of wavelengths to and/or from other optical signal wavelengths communicated within optical fiber 110.

Optical sensors 112 are capable of measuring one or more state properties within environment 104 and capable of communicating those measured state properties to controller 102 for processing. Although this example illustrates three sensors 112a-112c, any other number of sensors 112 can be used without departing from the scope of the present disclosure. Optical sensors 112 may comprise any optical device, mechanical device, electrical device, or combination thereof, that is capable of measuring one or more state properties within environment 104 and capable of communicating those measured state properties to controller 102.

In the illustrated example, optical sensors 112 include one or more sensing devices that are capable of measuring a fluctuation in one or more state properties. The sensing devices can comprise any device or combination of devices capable of measuring, for example, temperature, pressure, chemical species and/or any other state property of the bore-hole environment. The sensing devices can comprise, for example, one or more piezoelectric devices, such as, one or more quartz resonators. In particular embodiments, one or more of sensors 112 may be capable of detecting or sensing hydrogen, hydrogen sulfide, methane, Ph, gas oil fraction, or any other desired chemical species associated with the environment.

Optical sensors 112 also include at least one optical device capable of receiving an optical signal from light source 106 and communicating at least a portion of that optical signal to processor 108. In some cases the optical device may be capable of affecting one or more optical characteristics of the optical signal received from light source 106 and communicating the affected optical characteristics to processor 108 for processing.

The optical device of sensors 112 can comprise any device capable of affecting one or more optical characteristics of the optical signal. In this example, the optical device comprises an interferometer, such as, for example a Fabry-Perot interferometer, a Michelson interferometer, a Mach-Zender interferometer, or any other device that can change its optical reflection and/or reflection spectrum in response to an electrical and/or mechanical stimulus or signal from the sensing device. Although the optical device comprises an interferometer in this example, any other optical device may be used without departing from the scope of the present disclosure. A suitable stimulus can include, for example, a movement of the optical fiber, a movement of a portion of an optical device within an optical cavity, and/or a change in the electromagnetic field. In other embodiments, the optical device can comprise a fiber grating device, such as, for example, a Bragg grating, a long-period grating, or another other fiber grating device that is capable of manipulating one or more optical characteristics of the optical signal.

In various embodiments, the optical device of optical sensors 112 may be capable of converting at least a portion the optical power associated with the optical signal received from light source 106 into electrical power for use by the sensing device. In some cases, optical sensors 112 can convert a portion of the optical power into electrical power for use by the sensing device in measuring one or more state properties. In other cases, optical sensors 112 can convert a portion of the optical power into electrical power for use by the optical device in manipulating an optical characteristic of the optical signal that is received by the optical sensor.

In operation, optical sensors 112 receive an optical signal from light source 106 through optical fiber 110. In various embodiments, the optical signal can comprise, for example, a single wavelength signal, a multiple wavelength optical signal, an optical signal having a plurality of wavelength bands, or any combination of these or other optical signal types. After receiving the optical signal, each of sensors 112 operates to convert at least a portion of the optical power associated with the optical signal into electrical power. In some cases the electrical power can be used by optical sensors 112 to provide electrical power to the sensing device for use in sensing or detecting one or more state properties. In other cases, the electrical power can be used by optical sensors 112 to provide electrical power to the optical device for use in affecting one or more optical characteristics of an optical signal. In this particular embodiment, optical sensors 112 use the electrical power to provide power to both the sensing device and the optical device.

In this example, optical sensors 112 operate by having the one or more sensing devices measure one or more fluctuations in state properties. Each of the one or more sensing devices generates a sensing signal in response to a fluctuation in the one or more state properties and communicates the sensing signal to the one or more optical devices. The one or more optical devices use the sensing signals and at least a portion of the converted optical power to manipulate at least one optical characteristic of the optical signal received by optical sensors 112 and to communicate the manipulated optical signal to processor 108. Processor 108 operates to analyze the manipulated optical signal and associate the manipulated optical signal to the fluctuations in the one or more state properties measured by optical sensors 112. With proper calibration, the manipulated optical signal can be used to monitor the fluctuations in the state properties experienced by the sensing device of each of optical sensors 112.

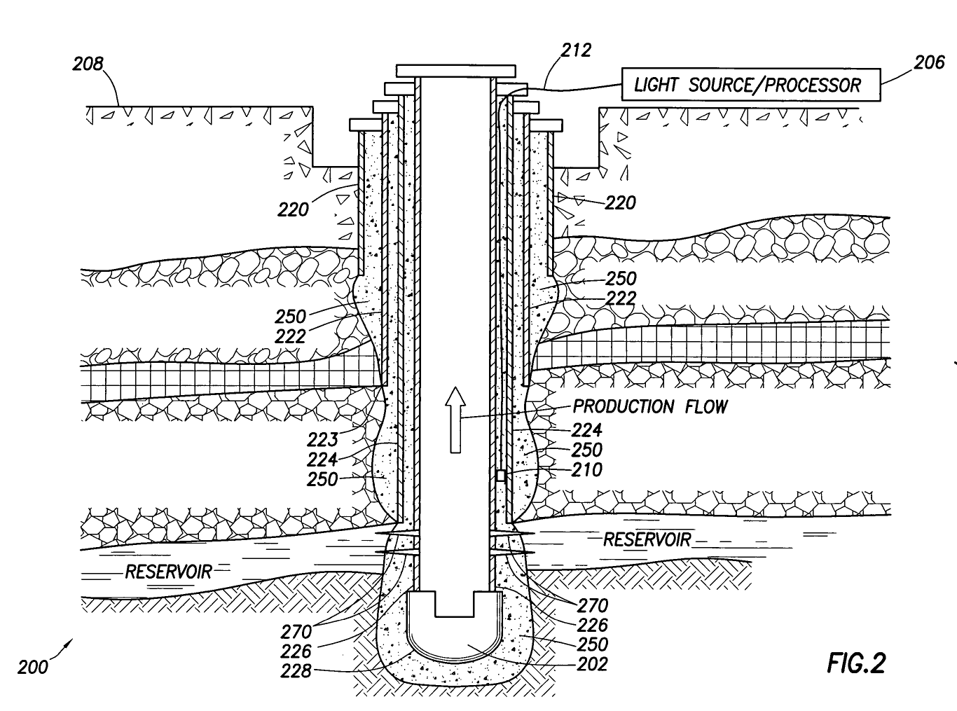

FIG. 2 is a block diagram of one example of a down-hole well system 200 that is capable of using the optical power of an optical signal to sense or detect a parameter within the well. In general, as a well is drilled, several casing strings are inserted into the bore hole. Each casing string is made up of casing joints that are connected using threaded couplings. Each string of casing is connected into the borehole as it is drilled. During drilling and completion, the drilling crew runs several strings of casing into the hole. Each casing string fits inside the last, so each string is smaller in diameter than the casing string set before it.

In this example, system 200 includes a conductor casing 220 that comprises a relatively short string of between 20 to 100 feet in length. The conductor casing 220 is a large diameter pipe that keeps the top part of the hole from caving in during drilling. The conductor casing 220 is drilled to just past the depth of the deepest fresh water in the formation in order to prevent drilling mud and hydrocarbons from contaminating fresh water (for drinking and/or irrigation purposes), and to keep loose sand or gravel from falling into the hole. A surface casing 222 is run within the conductor casing 220 and extends from the bottom of the hole 223 (the surface hole) to the surface 208.

After installing the surface casing 222, the crew continues drilling down to the oil reservoir. In a typical well, when the reservoir is very deep, the driller will often encounter troublesome formations, for example, one with high-pressure fluids in it. A high-pressure formation can cause oil and gas to blow out of the hole into the air, which is both dangerous and wasteful. By adjusting the properties of the drilling mud, a crew can successfully drill such formations. Later, however, as the hole passes through deeper formations, the mud they used to drill the high-pressure formation may no longer be suitable. So, to make it possible to drill deeper, the drill crew inserts an intermediate casing string 224. In some cases, intermediate casing string 224 is sealed within system 200 by, for example, cementing it with cement 250. Intermediate string 224 operates to seals off the high-pressure zone or other troublesome formations. The intermediate casing 224 fits inside the surface casing 222 and runs from the bottom of the hole thus far to the surface 208. As drilling progresses into the production zone, the drilling crew may set a second intermediate string of casing if they encounter more troublesome formations above the production zone.

When and if testing confirms the presence of hydrocarbons, the drilling crew may run the last string of casing, namely the production casing 226 (also called the oil string or long string). The production casing 226 usually runs from the bottom of the hole, or near the bottom, to the surface 208. At the bottom end of the production casing 226 is a casing shoe 228 (also called a guide shoe) at the end of the last joint. The casing shoe 228 is a short, heavy, cylindrical section of steel filled with concrete and rounded on the bottom. It prevents the production casing 226 from snagging on irregularities in the borehole as it is lowered.

A driller may pump salt water into the hole to contain pressure in the reservoir and formation until the well is completed and ready to produce. In this particular embodiment, system 200 comprises a cased-hole completion. To make a cased-hole completion, one or more perforations 270 are made in the production casing 226 and the surrounding cement 250. The perforations allow the hydrocarbons to flow from the reservoir into the production casing and eventually up to the surface 208.

In most cases, a production tubing string (not shown) is inserted within the production casing to improve the production of fluids from the production zone. The production tubing is perforated in the same place as the production casing (or is terminated with an open bottom at that depth), and the annulus between the production tubing and the production casing is sealed by a packer so that production will occur through the production tubing. Unlike the production casing, which is cemented in place, the production tubing can be removed with relative ease.

Once the well is producing, the production flows through production casing 226 toward surface 208. In this particular embodiment, system 200 includes an optical sensor 210 that is capable of monitoring one or more state properties associated with the production fluid and/or the environment within system 200. Although this example includes one optical sensor 210 within system 200, any additional number of sensors can be used without departing from the scope of the present disclosure. In some cases, sensor 210 can operate to monitor fluctuations in pressure and/or temperature associated with the production fluid or the environment within system 200. In other cases, sensor 210 can operate to monitor a chemical species associated with the production fluid and/or the environment in system 200. In this particular embodiment, sensor 210 operates to monitor the temperature, pressure, and chemical species associated with the production fluid and/or the environment of system 200. Although sensor 210 monitors temperature, pressure, and chemical species in this example, any state property or combination of state properties of system 200 can be monitored without departing from the scope of the present disclosure.

In various embodiments, sensor 210 can be positioned between production casing 226 and one of intermediate casings 224. In other embodiments, sensor 210 can be positioned within the production fluid. In some cases, sensor 210 can be coupled to the production tubing. In other cases, sensor 210 can be coupled to any of the casing strings and can be located such that sensor 210 monitors the conditions inside or outside the casing string to which the sensor is coupled. In this example, sensor 210 operates to receive one or more optical signals communicated from a light source within a transponder 206 through an optical fiber 212. Optical sensor 210 may comprise any optical device, mechanical device, electrical device, or combination thereof that is capable of measuring or detecting one or more state properties associated with the production fluid and/or the environment within system 200 and capable of communicating those measured state properties to transponder 206.

In the illustrated embodiment, optical sensor 210 includes at least one optical device capable of receiving an optical signal from transponder 206 and communicating at least a portion of that optical signal back to transponder 206. In some cases, the optical device of sensor 210 may be capable of affecting one or more optical characteristics of the optical signal received by sensor 210 and communicating the affected optical characteristics to transponder 206. In this example, transponder 206 also includes a processor to analyze the manipulated optical signal and associate the manipulated optical signal to the fluctuations in the one or more state properties measured by optical sensor 210. In some cases, transponder 206 may include one or more devices capable of performing optical-to-electrical and/or electrical-to-optical signal conversion and/or generation.

The optical device of sensor 210 can comprise any device capable of affecting one or more optical characteristics of the optical signal. In this example, the optical device comprises an interferometer, such as, for example, a Fabry-Perot interferometer, a Michelson interferometer, a Mach-Zender interferometer, or any other device that can change its optical reflection and/or reflection spectrum in response to an electrical, mechanical stimulus, and/or signal from a sensing device. Although the optical device of sensor 210 comprises an interferometer in this example, any other optical devices, such as, a fiber grating sensor, an evanescent sensor, or an intensity-based sensor, may be used without departing from the scope of the present disclosure.

In the illustrated example, sensor 210 also includes one or more sensing devices that are capable of measuring a fluctuation in one or more state properties of the production fluid and/or the environment of system 200. The sensing devices can comprise any device or combination of devices capable of measuring, for example, temperature, pressure, chemical species and/or other state properties of the bore-hole environment. For example, the sensing devices can comprise one or more piezoelectric devices, such as one or more shear-mode quartz resonators, or any other sensing devices that is capable of measuring pressure, temperature, chemical species, and/or other state properties of the environment and/or production fluid.

In those instances where power at down-hole or remote locations is either unavailable or insufficient, optical sensor 210 can comprise one or more devices capable of converting at least some of the optical power associated with the optical signal into electrical energy for use by sensor 210. For example, sensor 210 can include one or more photo-diodes capable of converting optical power into electrical current for use by sensor 210. In some cases, the electrical current can be used by sensor 210 to provide electrical power to an oscillator circuit and/or the sensing device. In other cases, the electrical current can be used by sensor 210 to provide electrical power to manipulate a moveable portion of the optical device. In this particular embodiment, sensor 210 uses the electrical current to provide power to both the sensing device and the optical device.

In operation, optical sensor 210 receives an optical signal from transponder 206. After receiving the optical signal, sensor 210 converts at least a portion of the optical power associated with the optical signal into an electrical current for use in providing power to measure one or more state properties associated with the production fluid and/or the environment within system 200.

In this example, sensor 210 uses the converted optical power to measure one or more state properties of the production fluid using the one or more sensing devices. Each of the one or more sensing devices generates a sensing signal in response to a fluctuation in the one or more state properties and communicates the sensing signal to the one or more optical devices of sensor 210. The one or more optical devices use the sensing signals and at least a portion of the converted optical power to manipulate at least one optical characteristic of the optical signal received by sensor 210 and to communicate the manipulated optical signal to transponder 206 for analysis.

In the illustrated embodiment, the optical device of sensor 210 comprises an interferometer. In an alternative embodiment, the optical device comprises a fiber grating device, such as, for example, a Bragg grating, a long-period grating, or another other fiber grating device that is capable of manipulating a wavelength that is reflected or transmitted to surface 208. Long-period gratings are responsive to changes in the curvature of the grating, and are also sensitive to axial strain in the grating as well as to changes in the refractive index of the material or materials surrounding the grating. Each grating can be designed to provide a single reflected or absorbed peak. This can be useful for situations when multiple sensors are used because each sensor can have a single reflected peak that is distinguished from the other sensors.

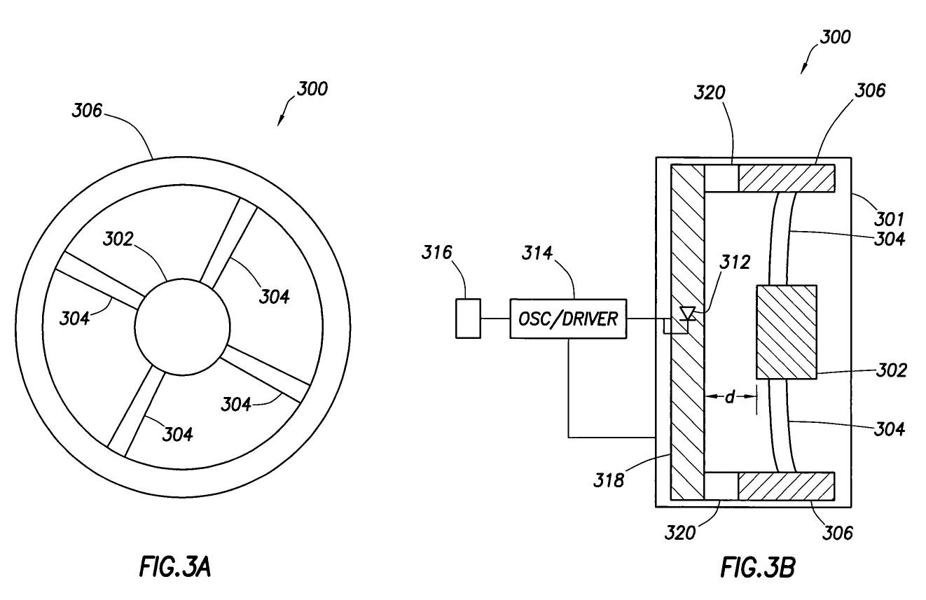

FIGS. 3a and 3b illustrate one example embodiment of a portion of a micro-electro-mechanical system (“MEMS”) device 300 that includes an interferometer 301. Although this example illustrates one example of an MEMS device 300, other MEMS devices may be used without departing from the scope of the present disclosure. FIG. 3a illustrates a front view of one example of MEMS device 300, while FIG. 3b illustrates a side view of MEMS device 300. In various embodiments, MEMS device 300 can comprise at least a portion of a MEMS device within an optical sensor located within a remote environment. In this example, MEMS device 300 includes interferometer 301 operable to selectively manipulate at least one optical characteristic of all or a portion of an optical signal received by MEMS device 300.

In this example, interferometer 301 comprises a moveable outer mirror element 302 and a stationary inner mirror element 318. In alternative embodiments, both the inner mirror element 318 and the outer mirror element 302 may comprise moveable mirror elements, or the inner mirror element 318 may comprise a moveable mirror element and the outer mirror element 302 may comprise a stationary mirror element. A space between the inner and outer mirror elements 318 and 302 defines an optical cavity of interferometer 301. Each mirror element 302 and 318 may comprise any number of layers of one or more materials capable of providing a desired optical response. For example, each mirror element 302 and 318 may comprise a single layer or a plurality of layers. In the illustrated embodiment, each mirror element 302 and 318 comprises an at least partially reflective material. The reflectivity of the material can be selected as a matter of design choice.

Interferometer 301 also includes a plurality of flex members 304 coupled to a frame 306 and outer mirror element 302, which are operable to move outer mirror element 302 relative to inner mirror element 318, causing a change in a depth “d” associated with the optical cavity of interferometer 301. The change in the depth “d” of the optical cavity can cause a change in one or more optical characteristics of interferometer 301. In some cases, changes in the depth “d” of the optical cavity by merely a few Ångstroms can create a detectable change in an optical signal communicated from interferometer 301.

In this particular embodiment, each of mirror elements 302 and 318 are operable to support a voltage differential between outer mirror element 302 and inner mirror element 318. Each of outer mirror element 302 and inner mirror element may comprise any conductive material capable of supporting a voltage differential between inner mirror element 318 and outer mirror element 302. In addition, each of outer mirror element 302 and inner mirror element may comprise any material capable of communicating all or a portion of an optical signal received by MEMS device 300. For example, mirror elements 302 and 318 may comprise one or more layers of doped silicon, poly-silicon, silicon dioxide, or silicon nitride.

Interferometer 301 also includes one or more insulation elements 320 residing between frame 306 and inner mirror element 318. In this example, insulation elements 320 are operable to electrically insulate inner mirror element 318 from outer mirror element 302. Insulation elements 320 can comprise a non-conductive material or a material surrounded by a non-conductive material to avoid shorting inner mirror element 318 and outer mirror element 302.

Interferometer 301 selectively communicates all or a portion of an optical signal received by MEMS device 300 by selectively modifying the depth “d” of the optical cavity of interferometer 301. In this example, outer mirror element 302 moves relative to inner mirror element 318 to selectively change the position of the movable outer mirror element and, consequently, the depth “d” of the optical cavity of interferometer 301. In this example, outer mirror element 302 moves in response to an electrostatic force created by placing a voltage differential between outer mirror element 302 and inner mirror element 318. Other force inducing mechanisms could be used consistent with the disclosure, such as thermoelectric, electro-magnetic, or piezo-electric forces.

In the illustrated embodiment, MEMS device 300 also includes a sensing device 316 operable to measure a fluctuation in one or more state properties. Sensing device 316 can comprise any device or combination of devices capable of measuring, for example, temperature, pressure, chemical species and/or any other state property. In this particular embodiment, sensing device 316 comprises one or more quartz resonators that use the inverse piezoelectric effect to induce a resonator (e.g., a quartz crystal) to vibrate at its mechanical resonant frequency when an electric field is applied. Although a quartz resonator is used in this example, any other sensing device capable of measuring one or more of pressure, temperature, chemical species, and/or any other state property can be used without departing from the scope of the present disclosure.

In various embodiments, sensing device 316 can comprise, for example, a quartz resonator pressure transducer capable of detecting a pressure associated with the environment. In those embodiments, sensing device 316 can comprise one or more quartz pressure crystals that change their mechanical resonant frequency in response to changes in pressure. For example, the quartz crystals can have a mechanical resonant frequency that fluctuates around 7.2 MHz depending on the pressure associated with the environment. In some cases, the temperature of the environment can have an affect on the mechanical resonant frequency of the pressure crystal. Thus, the pressure crystal should have a frequency response that is a strong function of pressure and a weak function of temperature.

In other embodiments, sensing device 316 can comprise, for example, a quartz resonator temperature transducer capable of detecting a temperature associated with the environment. In those embodiments, sensing device 316 can comprise one or more quartz temperature crystals that change their mechanical resonant frequency in response to changes in temperature. For example, the one or more quartz crystals can have a mechanical resonant frequency that fluctuates around 7.2 MHz depending on the temperature associated with the environment. In some cases, the pressure of the environment can have an affect on the mechanical resonant frequency of the temperature crystal. Thus, the temperature crystal should have a frequency response that is a strong function of temperature and a weak function of pressure. In some cases, to accurately detect or measure a fluctuation in either temperature or pressure using quartz resonators, both the pressure and temperature of the environment should be detected or measured.

In some embodiments, sensing device 316 can comprise, for example, a quartz resonator chemical species transducer operable to detect a chemical species associated with the environment. In those embodiments, sensing device 316 can comprise one or more quartz chemical species resonators that change their mechanical resonant frequency in response to the presence of a particular chemical species. For example, the quartz resonators can comprise a disk or lens quartz resonator that is coated with a chemical coating that changes its mass in the presence of a particular chemical species. The chemical species quartz resonator changes its mechanical resonant frequency in response to a change in mass associated with the chemical coating. In most cases, the temperature and pressure of the environment can have an affect on the mechanical resonant frequency of the chemical species quartz resonator. Thus, to accurately detect or measure a fluctuation in the chemical species using a quartz resonator within the environment, both the pressure and temperature of the environment should also be detected or measured.

In this particular embodiment, sensing device 316 is capable of measuring a fluctuation in temperature, pressure, and chemical species associated with an environment. Although sensing device 316 is capable of measuring a fluctuation in temperature, pressure, and chemical species in this example, sensing device 316 can measure any desired state property or combination of state properties without departing from the scope of the present disclosure. In various embodiments, sensing device 316 can comprise three quartz resonators each capable of measuring or detecting a particular state property. In some embodiments, sensing device 316 can comprise two quartz resonators each capable of measuring or detecting a particular state property. In other embodiments, sensing device 316 can comprise one quartz resonator capable of measuring or detecting a particular state property. Although a quartz resonator is implemented in these embodiments, any other sensing device capable of measuring or detecting a state property can be used without departing from the scope of the present disclosure.

MEMS device 300 also includes an oscillation/driver circuit 314 capable of manipulating and/or oscillating outer mirror element 302 in response to the one or more state properties measured or detected by sensing device 316. In this particular example, the mechanical resonant frequency associated with one or more quartz resonators of sensing device 316 operates to control an oscillation frequency associated with oscillation/driver circuit 314. For example, the fluctuation in the mechanical resonant frequency of the quartz crystals of a quartz resonator pressure transducer of sensing device 316 can operate to control the oscillation frequency of oscillation/driver circuit 314 in the range of 30,000 Hz to 50,000 Hz depending on the pressure associated with the environment. Moreover, the fluctuation in the mechanical resonant frequency of the quartz crystals of a quartz resonator temperature transducer of sensing device 316 can operate to control the oscillation frequency of oscillation/driver circuit 314 in the range of 9,000 Hz to 11,000 Hz depending on the temperature associated with the environment.

The oscillation frequency of oscillation/driver circuit 314 operates to create an oscillating or changing voltage differential between outer mirror element 302 and inner mirror element 318. The oscillating or changing voltage differential operates to create an oscillating or changing electrostatic force between inner mirror element 318 and outer mirror element 302, which allows interferometer 301 to selectively manipulate at least one optical characteristic of at least a portion of the optical signal communicated from MEMS device 300.

In this particular embodiment, interferometer 301 includes one or more photo-diodes 312 capable of 2 at least some of the optical power associated with an optical signal received by interferometer 301 into electrical energy for use by MEMS device 300. In this example, the one or more photo-diodes 312 are incorporated into or reside within the material associated with inner mirror element 318. In most cases, at least a majority of the power associated with the optical signal received by interferometer 301 is converted into electrical power and the remainder of the optical power is communicated from interferometer 301. In some cases, at least ninety percent (90%) of the power associated with the optical signal received by interferometer 301 is communicated to photo-diodes for conversion into electrical power and no more than ten percent (10%) of the optical power is communicated from interferometer 301. In other cases, at least ninety-five percent (95%) of the power associated with the optical signal received by interferometer 301 is communicated to photo-diodes for conversion into electrical power and no more than five percent (5%) of the optical power is communicated from interferometer 301.

In this example, the one or more photo-diodes 312 reside within interferometer 301. In an alternative embodiment, the one or more photo-diodes 312 can reside external to interferometer 301. In that embodiment, MEMS device 300 can include an optical power divider or power splitter capable of dividing the optical power of the optical signal received by MEMS device 300 into at least a first part and a second part. For example, the optical power divider may comprise a 50/50 power divider, an 80/20 power divider, a 90/10 power divider, a 95/5 power divider, or any other appropriate power divider. In one particular embodiment, MEMS device 300 includes a 90/10 power divider that divides the power of the optical signal into a first part having approximately 90% of the optical power and a second part having approximately 10% of the optical power. The first part of the divided optical signal can be communicated to the one or more photo-diodes for conversion into electrical power and the second part of the divided optical signal can be communicated to interferometer 301.

In some cases, the optical power converted into electrical power by the one or more photo-diodes 312 can be used by MEMS device 300 to provide electrical power to sensing device 316 to detect or sense one or more state-properties. In other cases, optical power converted by the one or more photo-diodes 312 into electrical power can be used by MEMS device 300 to provide electrical power to oscillator/driver circuit 314 to manipulate outer mirror element 302 relative to inner mirror element 318. In the illustrated embodiment, MEMS device 300 uses the converted electrical power to provide power to both sensing device 316 and oscillator/driver circuit 314.

In operation, MEMS device 300 receives an optical signal from a light source residing external to MEMS device 300. After receiving the optical signal, photo-diode 312 converts at least a portion of the optical power associated with the optical signal into an electrical current for use in providing electrical power to sensing device 316 and/or oscillation/driver circuit 314.

In this example, sensing device 316 includes one or more quartz resonators that use the converted optical power to measure one or more state properties of the environment. Each of the one or more quartz resonators generates a mechanical resonant frequency in response to a fluctuation in the one or more state properties and communicates that mechanical resonant frequency to oscillation/driver circuit 314. Oscillation/driver circuit 314 uses the mechanical resonant frequency of the quartz resonator and at least a portion of the converted optical power to oscillate or manipulate the position of outer mirror element 302 relative to inner mirror element 318. The oscillation or manipulation of outer mirror element 302 operates to manipulate or change at least one optical characteristic of at least a portion of the optical signal received by MEMS device 300. MEMS device 300 then communicates the manipulated optical signal to a transponder residing external to MEMS device 300 for analysis.

In this particular embodiment, MEMS device 300 includes a sensing device 316 capable of measuring or detecting one or more state properties, an oscillation/driver circuit 314 coupled to the sensing device 316, and an interferometer 301 capable of selectively manipulating at least one optical characteristic of the portion of the optical signal communicated from MEMS device 300. In other embodiments, MEMS device 300 can include three sensing devices 316 each capable of detecting or measuring a particular state property, three oscillation/driver circuits 314 each coupled to a particular sensing device 316, and one interferometer 301 capable of selectively manipulating at least one optical characteristic of a portion of the optical signal. In an alternative embodiment, MEMS device 300 can include three sensing devices 316 each capable of detecting or measuring a particular state property, three oscillation/driver circuits 314 each coupled to a particular sensing device 316, and three interferometers 301 each capable of selectively manipulating at least one optical characteristic of a portion of the optical signal.

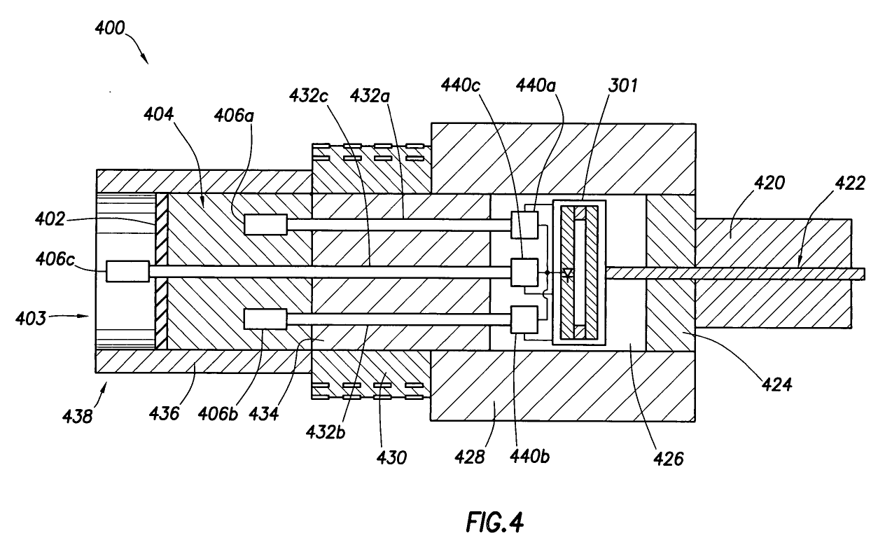

FIG. 4 illustrates one example of an optical sensor 400 capable of using the optical power of an optical signal to sense or detect a parameter at a remote location. In this example, sensor 400 includes an optical section 426 capable of selectively manipulating at least one optical characteristic of all or a portion of an optical signal received by sensor 400. Optical section 426 includes interferometer 301, oscillation/driver circuits 440, and an optical fiber 422. The structure and function of oscillation/driver circuits 440 and optical fiber 422 can be substantially similar to the structure and function of oscillation/driver circuit 314 and optical fiber 110 of FIGS. 3 and 1, respectively. Although this example includes interferometer 301, any other interferometer can be used without departing from the scope of the present disclosure.

Sensor 400 also includes a sensor section 438 capable of sensing and/or detecting a fluctuation in one or more state properties associated with an environment. In the illustrated embodiment, sensing section 438 includes a membrane 402 that is capable of transmitting any pressure and/or temperature fluctuation associated with environment 403 to a transfer medium 404. Membrane 402 can comprise any material that is capable of transmitting the pressure and/or temperature associated with environment 403. Transfer medium 404 can comprise any material capable of conveying any pressure and/or temperature fluctuation associated with environment 403 to one or more sensing elements located within medium 404.

Sensor section 438 also includes a pressure sensing element 406a, a temperature sensing element 406b, and a chemical species sensing element 406c each capable of measuring and/or detecting a fluctuation in one or more state properties of environment 403. In some embodiments, the structure and function of sensing elements 406 can be substantially similar to the structure and function of sensing element 316 of FIG. 3. Although this example includes three sensing elements 406a-406c, sensing section 438 can include any additional number of sensing elements 406 or can exclude one or more of sensing elements 406 without departing from the scope of the present disclosure.

In this example, pressure sensing element 406a comprises a quartz resonator pressure transducer capable of measuring or detecting a pressure fluctuation within environment 403, while temperature sensing element 406b comprises a quartz resonator temperature transducer capable of measuring or detecting a fluctuation in temperature within environment 403. Although both of elements 406a and 406b comprise quartz resonators in this example, any other device or combination of devices capable of measuring or detecting a particular state property can be used without departing from the scope of the present disclosure. In various embodiments, temperature sensing element 406b can include a housing or shield capable of substantially isolating and/or minimizing any pressure affects that would otherwise be imparted on element 406b by transfer medium 404.

In this embodiment, chemical species sensing element 406c comprises a quartz chemical species transducer capable of detecting or measuring a fluctuation in a chemical species associated with the environment. Although element 406c comprises a quartz resonator in this example, any other device or combination of devices capable of measuring or detecting a fluctuation in chemical species can be used without departing from the scope of the present disclosure. In various embodiments, chemical species sensing element 406c can measure or detect a fluctuation in, for example, hydrogen, hydrogen sulfide, methane, Ph, gas oil fraction, or any other desired chemical species associated with the environment.

Sensor 400 also includes a feed-through section 434 that is capable of isolating optical section 426 from sensor section 438. Feed-through section 434 can comprise any suitable material, such as, for example, plastic, glass, poly-ether-ether-ketone (“PEEK”), or other suitable material. In some cases, feed-through section 434 can function as a hermetic seal that allows optical section 426 to operate at or near a vacuum. In this example, feed-through section 434 includes conductors 432 each capable of coupling a particular sensing element 406 to a particular oscillation/driver circuit 440. Sensor 400 also includes housing elements 420, 424, 428, 430, and 436 that are capable of providing a pressure boundary for sensor 400. Housing elements 420, 424, 428, and 430 can comprise any corrosion resistant material, such as, for example, Stainless Steel, Inconel, Incoloy, or any other corrosion resistant metal alloy.

In operation, sensor 400 receives an optical signal communicated from a light source residing external to sensor 400 through optical fiber 422. Optical fiber 422 operates to communicate the optical signal to interferometer 301. In this example, interferometer 301 includes one or more photo-diodes 312 that operate to receive at least ninety percent (90%) of the optical power associated with the optical signal and to convert at least some of the received optical power into electrical energy for use by sensor 400. Although photo-diodes 312 operate to receive ninety percent (90%) of the optical power in this example, any other amount of optical power can be received without departing from the scope of the present disclosure.

Sensor 400 operates to convey at least a portion of the electrical power to sensing elements 406 through conductors 432. In this example, the electrical power provided to each of sensing elements 406 operates to cause a quartz resonator associated with each of sensing elements 406 to vibrate at its mechanical resonant frequency. A fluctuation in either of the temperature, pressure, and/or chemical species associated with environment 403 can have an affect on the mechanical resonant frequency associated with one or more of the quartz resonators of sensing elements 406.

In some cases, a temperature fluctuation within environment 403 can have a strong affect on the mechanical resonant frequency of the quartz resonator of temperature sensing element 406b. In that case, the temperature fluctuation can also have a weak affect on the mechanical resonant frequency of the quartz resonator of pressure sensing element 406a. In other cases, a pressure fluctuation within environment 403 can have a strong affect on the mechanical resonant frequency of the quartz resonator of pressure sensing element 406a. In that case, the pressure fluctuation can also have a weak affect on the mechanical resonant frequency of the quartz resonator of temperature sensing element 406b.

In this example, each of sensing devices 406 operates to communicate its mechanical resonant frequency to its respective oscillation/driver circuit 440. For example, pressure sensing element 406a communicates it mechanical resonant frequency to oscillation/driver circuit 440a, while chemical species sensing element 406c communicates its mechanical resonant frequency to oscillation/driver circuit 440c. Each of oscillation/driver circuits 440 receives the mechanical resonant frequency and uses the mechanical resonant frequency of the quartz resonator to generate a sensing/driving signal. In this particular embodiment, sensor 400 combines each of the sensing/driving signals communicated from circuits 440 at interferometer 301. Interferometer 301 uses the combined sensing/driving signals and at least a portion of the converted optical power to oscillate or manipulate the position of outer mirror element 302 relative to inner mirror element 318. The oscillation or manipulation of outer mirror element 302 operates to manipulate or change at least one optical characteristic of at least a portion of the optical signal received by interferometer 301. Interferometer 301 communicates the manipulated optical signal to a processor (e.g., processor 108 of FIG. 1) for analysis through optical fiber 422.

In this particular embodiment, sensor 400 includes three sensing devices 406, three oscillation/driver circuit 440, and an interferometer 301. In other embodiments, sensor 400 can include three sensing devices 406 each capable of detecting or measuring a particular state property, one oscillation/driver circuit 440 coupled each of sensing devices 406, and one interferometer 301. In an alternative embodiment, sensor 400 can include three sensing devices 406, three oscillation/driver circuits 440 each coupled to a particular sensing device 406, and three interferometers 301 each coupled to a particular oscillation/driver circuit 440. In yet another embodiment, sensor 400 can include one sensing device 406, one oscillation circuit 440, and one interferometer 301.

In this example, interferometer 301 includes one or more photo-diodes 312 capable of converting at least a portion of the optical power into electrical power for use by sensor 400. In an alternative embodiment, the one or more photo-diodes 312 can reside external to interferometer 301. In that embodiment, sensor 400 can include an optical power divider or power splitter coupled to optical fiber 422 and capable of dividing the optical power of the optical signal received by sensor 400 into at least a first part and a second part. For example, the optical power divider may comprise a 50/50 power divider, an 80/20 power divider, a 90/10 power divider, a 95/5 power divider, or any other appropriate power divider. In particular embodiments, sensor 400 can include a 90/10 power divider that divides the power of the optical signal into a first part having approximately 90% of the optical power and a second part having approximately 10% of the optical power. The first part of the divided optical signal can be communicated to the one or more photo-diodes for conversion into electrical power and the second part of the divided optical signal can be communicated to interferometer 301.

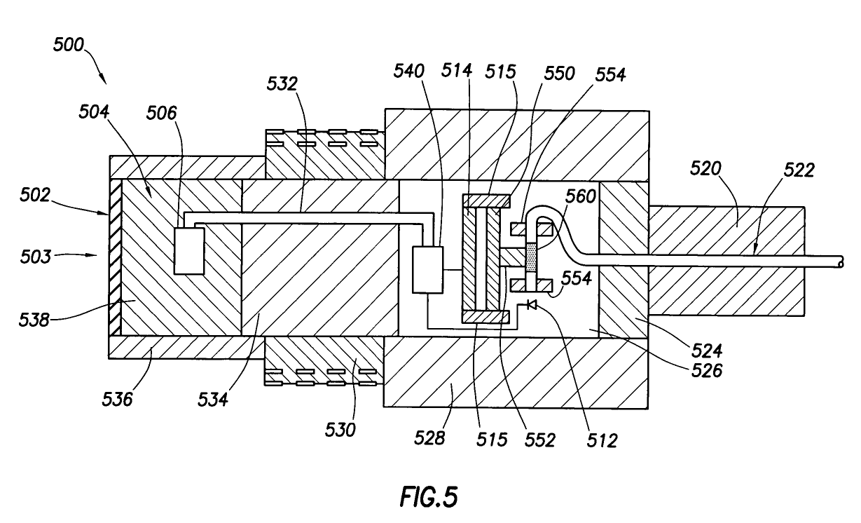

FIG. 5 illustrates one example of an optical sensor 500 capable of using the optical power of an optical signal to sense or detect a parameter at a remote location. In this example, sensor 500 also includes a sensor section 538 capable of sensing and/or detecting a fluctuation in one or more state properties associated with an environment. In the illustrated embodiment, sensing section 538 includes a membrane 502, a transfer medium 504, and a sensing element 506. The structure and function of membrane 502, medium 504, and sensing element 506 can be substantially similar to the structure and function of membrane 402, medium 404, and sensing element 406 of FIG. 4, respectively. Although this example includes one sensing element 506, sensing section 538 can include any additional number of sensing elements 506 without departing from the scope of the present disclosure.

In this example, sensing element 506 comprises a quartz resonator capable of measuring or detecting a fluctuation within environment 503. Although element 506 comprises a quartz resonator in this example, any other device or combination of devices capable of measuring or detecting a particular state property can be used without departing from the scope of the present disclosure. In various embodiments, sensing element 506 may be able to sense or detect temperature, pressure, chemical species, and/or any other state property.

Sensor 500 also includes an optical section 526 capable of selectively manipulating at least one optical characteristic of all or a portion of an optical signal received by sensor 500. Optical section 526 includes an oscillation/driver circuit 540 and an optical fiber 522. The structure and function of oscillation/driver circuit 540 and optical fiber 522 can be substantially similar to the structure and function of oscillation/driver circuit 440 and optical fiber 422 of FIG. 4, respectively.

Optical section 526 also includes a grating 560 capable selectively manipulating at least one optical characteristic of all or a portion of an optical signal received by sensor 500. Grating 560 can comprise any grating capable of affecting and/or changing one or more optical characteristics of an optical signal, such as, for example, a Bragg grating, a long-period grating, or another other fiber grating device that is capable of manipulating a wavelength that is reflected or transmitted from sensor 500. Long-period gratings are responsive to changes in the curvature of the grating, and are also sensitive to axial strain in the grating as well as to changes in the refractive index of the material or materials surrounding the grating. Each grating can be designed to provide a single reflected or absorbed peak.

In this example, optical section 526 includes a moveable element 550 that is coupled to grating 560 and that operates to move relative to a stationary element 514. A change in the reflective index of grating 560 can cause a change in one or more optical characteristics of an optical signal communicated from sensor 500. In this particular embodiment, each of elements 550 and 514 are operable to support a voltage differential between moveable element 550 and stationary element 514. Each of moveable element 550 and stationary element 514 may comprise any conductive material capable of supporting a voltage differential between moveable element 550 and stationary element 514.

Optical section 526 further includes one or more insulation elements 515 residing between moveable element 550 and stationary element 514. In this example, insulation elements 515 are operable to electrically isolate stationary element 514 from moveable element 550. Insulation elements 515 can comprise a non-conductive material or a material surrounded by a non-conductive material to avoid shorting stationary element 514 and moveable element 550.

In this particular embodiment, optical section 526 includes one or more photo-diodes 512 coupled to optical fiber 522. Photo-diodes 512 are capable of converting at least some of the optical power associated with an optical signal received by sensor 500 into electrical energy for use by oscillation/driver circuit 540 and/or sensing element 506. In most cases, at least a majority of the power associated with the optical signal received by sensor 500 is communicated to photo-diodes 512 for conversion into electrical power and the remainder of the optical power is communicated from sensor 500. In some cases, at least ninety percent (90%) of the power associated with the optical signal received by sensor 500 is communicated to photo-diodes 512 for conversion into electrical power and no more than ten percent (10%) of the optical power is communicated from sensor 500. In other cases, at least ninety-five percent (95%) of the power associated with the optical signal received by sensor 500 is communicated to photo-diodes 512 for conversion into electrical power and no more than five percent (5%) of the optical power is communicated from sensor 500.

Sensor 500 also includes a feed-through section 534 that is capable of isolating optical section 526 from sensor section 538. Feed-through section 534 can comprise any suitable material, such as, for example, plastic, glass, poly-ether-ether-ketone (“PEEK”), or other suitable material. In some cases, feed-through section 534 can function as a hermetic seal that allows optical section 526 to operate at or near a vacuum. In this example, feed-through section 534 includes conductors 532 each capable of coupling a particular sensing element 506 to a particular oscillation/driver circuit 540. Sensor 500 also includes housing elements 520, 524, 528, 530, and 536 that are capable of providing a pressure boundary for sensor 500. Housing elements 520, 524, 528, and 530 can comprise any corrosion resistant material, such as, for example, Stainless Steel, Inconel, Incoloy, or any other corrosion resistant metal alloy.

In operation, sensor 500 receives an optical signal communicated from a light source residing external to sensor 500 through optical fiber 522. Optical fiber 522 operates to communicate the optical signal to grating 560.

In this example, the end of optical fiber 522 is coupled to one or more photo-diodes 512 that operate to receive at least ninety percent (90%) of the optical power associated with the optical signal and to convert at least some of the received optical power into electrical energy for use by sensor 500. Although photo-diodes 512 operate to receive ninety percent (90%) of the optical power in this example, any other amount of optical power can be received without departing from the scope of the present disclosure.

Sensor 500 operates ton convey at least a portion of the electrical power to sensing element 506 through conductor 532. In this example, the electrical power provided to sensing element 506 operates to cause a quartz resonator associated with sensing element 506 to vibrate at its mechanical resonant frequency. A fluctuation in the temperature, pressure, and/or chemical species associated with environment 503 can have an affect on the mechanical resonant frequency associated with one or more of the quartz resonators of sensing element 506.

In this example, sensing device 506 operates to communicate its mechanical resonant frequency to oscillation/driver circuit 540. Oscillation/driver circuit 540 uses the mechanical resonant frequency of the quartz resonator and at least a portion of the converted optical power to oscillate or manipulate the position of moveable element 550 relative to stationary element 514. The oscillation or manipulation of moveable element 550 operates to manipulate or change the reflective index of grating 560, which affects at least one optical characteristic of at least a portion of the optical signal received by grating 560. Grating 560 communicates the manipulated optical signal to a processor (e.g., processor 108 of FIG. 1) for analysis through optical fiber 522.

In this particular embodiment, optical section 526 of sensor 500 implements a grating 560 that is capable of changing or manipulating an optical characteristic of an optical signal received by sensor 500. In alternative embodiments, optical section 526 can replace grating 560 with an evanescence interferometer or long-period grating having a curvature. In those embodiments, movement of moveable element 550 operate to change the curvature of the evanescence interferometer or long-period grating and, therefore, changes an interference pattern in the portion of the optical signal communicated from sensor 500.

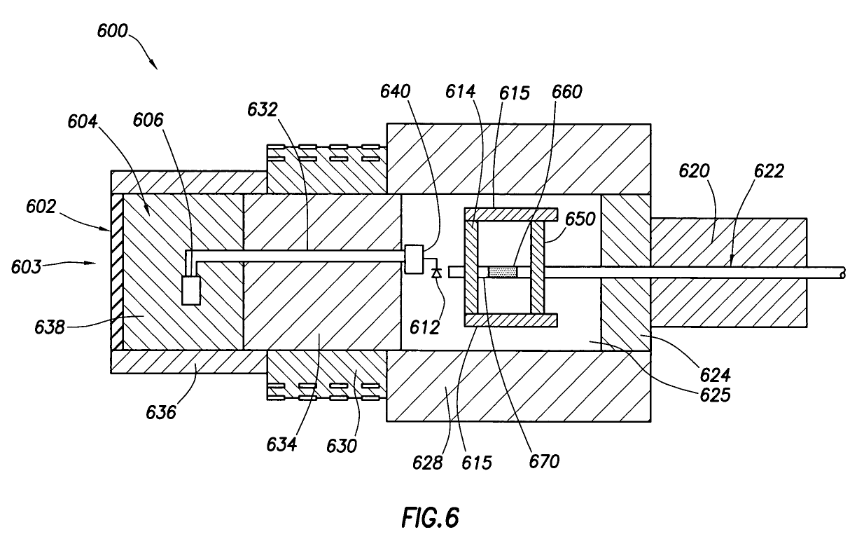

FIG. 6 illustrates one example of an optical sensor 600 capable of using the optical power of an optical signal to sense or detect a parameter at a remote location. In this example, sensor 600 also includes a sensor section 638 capable of sensing and/or detecting a fluctuation in one or more state properties associated with an environment. In the illustrated embodiment, sensing section 638 includes a membrane 602, a transfer medium 604, and a sensing element 606. The structure and function of membrane 602, medium 604, and sensing element 606 can be substantially similar to the structure and function of membrane 402, medium 404, and sensing element 406 of FIG. 4, respectively. Although this example includes one sensing element 606, sensing section 638 can include any additional number of sensing elements 606 without departing from the scope of the present disclosure.

In this example, sensing element 606 comprises a quartz resonator capable of measuring or detecting a fluctuation within environment 603. Although element 606 comprises a quartz resonator in this example, any other device or combination of devices capable of measuring or detecting a particular state property can be used without departing from the scope of the present disclosure. In various embodiments, sensing element 606 may be able to sense or detect temperature, pressure, chemical species, and/or any other state property.

Sensor 600 also includes an optical section 626 capable of selectively manipulating at least one optical characteristic of all or a portion of an optical signal received by sensor 600. Optical section 626 includes an oscillation/driver circuit 640 and an optical fiber 622. The structure and function of oscillation/driver circuit 640 and optical fiber 622 can be substantially similar to the structure and function of oscillation/driver circuit 440 and optical fiber 422 of FIG. 4, respectively. In this example, optical section 626 also includes grating 660, moveable element 650, stationary element 614, insulation elements 615, and one or more photo-diodes 612. The structure and function of grating 660, moveable element 650, stationary element 614, insulation elements 615, and photo-diodes 612 can be substantially similar to the structure and function of grating 560, moveable element 550, stationary element 514, insulation elements 515, and photo-diodes 512 of FIG. 5, respectively.

Sensor 600 also includes a feed-through section 634 that is capable of isolating optical section 626 from sensor section 638. Feed-through section 634 can comprise any suitable material, such as, for example, plastic, glass, poly-ether-ether-ketone (“PEEK”), or other suitable material. In some cases, feed-through section 634 can function as a hermetic seal that allows optical section 626 to operate at or near a vacuum. In this example, feed-through section 634 includes conductors 632 each capable of coupling a particular sensing element 606 to a particular oscillation/driver circuit 640. Sensor 600 also includes housing elements 620, 624, 628, 630, and 636 that are capable of providing a pressure boundary for sensor 600. Housing elements 620, 624, 628, and 630 can comprise any corrosion resistant material, such as, for example, Stainless Steel, Inconel, Incoloy, or any other corrosion resistant metal alloy.

In operation, sensor 600 receives an optical signal communicated from a light source residing external to sensor 600 through optical fiber 622. Optical fiber 622 operates to communicate the optical signal to grating 660. In this example, the end of optical fiber 622 is coupled to one or more photo-diodes 612 that operate to receive at least ninety percent (90%) of the optical power associated with the optical signal and to convert at least some of the received optical power into electrical energy for use by sensor 600. Although photo-diodes 612 operate to receive ninety percent (90%) of the optical power in this example, any other amount of optical power can be received without departing from the scope of the present disclosure.

Sensor 600 operates to convey at least a portion of the electrical power to sensing element 606 through conductor 632. In this example, the electrical power provided to sensing element 606 operates to cause a quartz resonator associated with sensing element 606 to vibrate at its mechanical resonant frequency. A fluctuation in the temperature, pressure, and/or chemical species associated with environment 603 can have an affect on the mechanical resonant frequency associated with one or more of the quartz resonators of sensing element 606.

In this example, sensing device 606 operates to communicate its mechanical resonant frequency to oscillation/driver circuit 640. Oscillation/driver circuit 640 uses the mechanical resonant frequency of the quartz resonator and at least a portion of the converted optical power to oscillate or manipulate the position of moveable element 650 relative to stationary element 614. The oscillation or manipulation of moveable element 650 operates to apply a tensile or compressive force to grating 660, which operates to manipulate or change the reflective index of grating 660. Changing the reflective index of grating 660 manipulates or changes at least one optical characteristic of at least a portion of the optical signal received by grating 660. Grating 660 communicates the manipulated optical signal to a processor (e.g., processor 108 of FIG. 1) for analysis through optical fiber 622.

FIG. 7 is a flow chart illustrating one example embodiment of a method 500 of using at least a portion of optical power of an optical signal to sense or detect a parameter of a remote environment. In one particular embodiment, light sources 106 may communicate one or more optical signals, which may be received by one or more sensors 112 of FIG. 1. Although system 100 is used in this example, other systems may be used without departing from the scope of the present disclosure. In this example, each of optical sensors 112 comprises interferometer 301 of MEMS device 300 of FIG. 3. In other embodiments, the optical device of sensors 112 can comprise any other interferometer or fiber grating device without departing from the scope of the present disclosure. Sensors 112 also include one or more oscillation/driver circuits 314 and one or more sensing devices 316 of FIG. 3. In various embodiments, sensor 112 can include pressure sensing device 406a, temperature sensing device 406b, chemical species sensing device 406c, and their corresponding oscillation/driver circuit 440a-440c of FIG. 4.

Method 700 begins at step 710 where sensor 112 converts at least a portion of optical power of an optical signal into electrical power for use by sensor 112. In this example, sensor 112 receives the optical signal from light source 106 residing external to sensor 112 through optical fiber 110. In various embodiments, the optical signal can comprise, for example, a single wavelength signal, a multiple wavelength optical signal, an optical signal having a plurality of wavelength bands, or any combination of these or other optical signal types.

Optical fiber 110 operates to communicate the optical signal to interferometer 301. In particular embodiments, interferometer 301 includes one or more photo-diodes 312 that operate to receive at least ninety percent (90%) of the optical power associated with the optical signal and to convert at least some of the received optical power into electrical energy for use by sensor 112. Although photo-diodes 312 operate to receive ninety percent (90%) of the optical power in this example, any other amount of optical power can be received without departing from the scope of the present disclosure.

In this example, sensor 112 provides at least a portion of the electrical power to one or more sensing devices (e.g., sensing devices 316 of FIG. 3) for use in sensing or detecting one or more state properties at step 720. In some embodiments, sensor 112 can operate to convey at least a portion of the electrical power to sensing elements 316 through one or more conductors (e.g., conductors 432 of FIG. 4) for use in sensing or detecting one or more state properties of environment 104. In this example, the electrical power provided to each of sensing elements 316 operates to cause a quartz resonator associated with sensing elements 316 to vibrate at its mechanical resonant frequency. A fluctuation in either of the temperature, pressure, and/or chemical species associated with environment 104 can have an affect on the mechanical resonant frequency associated with one or more of the quartz resonators of sensing elements 316.

In some cases, a temperature fluctuation within environment 104 can have a strong affect on the mechanical resonant frequency of the quartz resonator of a temperature sensing element (e.g., sensing element 406b of FIG. 4). In that case, the temperature fluctuation can also have a weak affect on the mechanical resonant frequency of the quartz resonator of a pressure sensing element (e.g., sensing element 406a of FIG. 4). In other cases, a pressure fluctuation within environment 104 can have a strong affect on the mechanical resonant frequency of the quartz resonator of a pressure sensing element (e.g., sensing element 406a of FIG. 4). In that case, the pressure fluctuation can also have a weak affect on the mechanical resonant frequency of the quartz resonator of a temperature sensing element (e.g., sensing element 406b of FIG. 4).

In this example, sensing devices 316 communicate one or more sensing signals that were generated in response to a fluctuation in the one or more state properties to an oscillation/driver circuit (e.g., oscillation/driver circuit 314 of FIG. 3) of sensor 112 at step 730. In some cases, oscillation/driver circuits 314 receive the mechanical resonant frequency and use the mechanical resonant frequency of the quartz resonator to generate a sensing/driving signal. In this particular embodiment, sensor 112 combines the sensing/driving signals communicated from circuits 314 at interferometer 301.

In this example, sensor 112 manipulates at least one optical characteristic of the optical signal based at least in part on the sensing signal received from sensing device 314 and using at least a portion of the converted optical power at step 740. In some cases, interferometer 301 uses the sensing/driving signals and at least a portion of the converted optical power to oscillate or manipulate the position of outer mirror element 302 relative to inner mirror element 318 to affect at least one optical characteristic of the optical signal.

The oscillation or manipulation of outer mirror element 302 operates to manipulate or change at least one optical characteristic of at least a portion of the optical signal received by interferometer 301. Interferometer 301 communicates the manipulated optical signal to processor 108 of FIG. 1 for analysis through optical fiber 110. Processor 108 operates to analyze the manipulated optical signal and associate the manipulated optical signal to the fluctuations in the one or more state properties measured by optical sensors 112. With proper calibration, the manipulated optical signal can be used to monitor the fluctuations in the state properties experienced by the sensing device of each of optical sensors 112.

Although the present invention has been described in several embodiments, a myriad of changes, variations, alterations, transformations, and modifications may be suggested to one skilled in the art, and it is intended that the present invention encompass such changes, variations, alterations, transformations, and modifications as falling within the spirit and scope of the appended claims.

What is claimed is:

1. A sensor capable of using at least a portion of optical power of an optical signal to sense one or more state properties, the sensor comprising:
one or more optical-to-electrical conversion devices operable to convert at least a portion of an optical power of an optical signal received by a sensor to electrical power;
one or more sensing devices coupled to the optical-to-electrical conversion devices, the sensing devices operable to detect one or more state properties of an environment and to generate one or more sensing signals in response to the detected state properties, the sensing devices using at least a portion of the electrical power to detect the one or more state properties; and
one or more optical devices operable to manipulate one or more optical characteristics of the optical signal based at least in part on the sensing signal and to communicate at least a portion of the manipulated optical signal from the sensor.

2. The sensor of claim 1, wherein the optical devices comprises an interferometer capable of manipulating the one or more optical characteristics of the optical signal based at least in part on a sensing signal.

3. The sensor of claim 2, wherein the interferometer comprises a stationary mirror element and a moveable mirror element, the moveable mirror element operable to move relative to the stationary mirror element in response to an electrostatic force.

4. The sensor of claim 3, wherein a space between the moveable mirror element and the stationary mirror element operates to define an optical cavity and wherein a change in a depth of the optical cavity operates to manipulate the one or more optical characteristics of the optical signal.

5. The sensor of claim 3, wherein the interferometer uses at least another portion of the electrical power to move the moveable mirror element relative to the stationary mirror element.

6. The sensor of claim 1, wherein the one or more state properties are selected from the group consisting of temperature, pressure, and chemical species.

7. The sensor of claim 1, wherein the sensing devices comprises one or more quartz resonators.

8. The sensor of claim 7, further comprising:
an oscillator circuit coupled to the one or more quartz resonators, the oscillation circuit operable to generate an oscillation frequency based at least in part on a mechanical resonant frequency of a crystal of the quartz resonator; and
a driver circuit capable of changing a reflective property of the optical device based at least in part on the oscillation frequency generated by the oscillator circuit.

9. The sensor of claim 1, wherein the sensing devices comprise:
a first quartz resonator operable to detect a pressure associated with the environment, the first quartz resonator comprising a pressure crystal having a mechanical resonant frequency response that is a strong function of pressure and a weak function of temperature;
a second quartz resonator operable to detect a temperature associated with the environment, the second quartz resonator comprising a temperature crystal having a mechanical resonant frequency response that is a strong function of temperature and a weak function of pressure; and
a third quartz resonator operable to detect a chemical species associated with the environment, the third quartz resonator comprising a chemical crystal that comprises a chemical coating operable to absorb a particular chemical species and to change the mass of the chemical crystal.

10. The sensor of claim 1, wherein the one or more optical-to-electrical conversion devices comprises an array photo-diodes capable of converting the optical power into electrical power.

11. A sensor capable of using at least a portion of an optical power of an optical signal to sense one or more state properties, the sensor comprising:
one or more optical-to-electrical conversion devices operable to convert at least a portion of optical power of an optical signal received by a sensor to electrical power;
one or more sensing devices operable to detect one or more state properties of an environment and to generate one or more sensing signals in response to the detected state properties; and
one or more optical devices coupled to at least some of the optical-to-electrical conversion devices, the one or more optical devices operable to manipulate one or more optical characteristics of the optical signal based at least in part on the sensing signal and to communicate at least a portion of the manipulated optical signal from the sensor, at least one of the optical devices using at least a portion of the electrical power to change a reflective property of the at least one optical device, wherein the change in the reflective property operates to manipulate at least one of the one or more optical characteristics.

12. The sensor of claim 11, wherein the sensing devices use at least another portion of the electrical power to detect the one or more state properties.

13. The sensor of claim 11, wherein the optical devices comprises an interferometer capable of manipulating the one or more optical characteristics of the optical signal based at least in part on a sensing signal.

14. The sensor of claim 13, wherein the interferometer comprises a stationary mirror element and a moveable mirror element, the moveable mirror element operable to move relative to the stationary mirror element in response to an electrostatic force created by the portion of the electrical power.

15. The sensor of claim 14, wherein a space between the moveable mirror element and the stationary mirror element operates to define an optical cavity and wherein a change in a depth of the optical cavity operates to change the reflective property of the interferometer.

16. The sensor of claim 11, wherein the sensing devices comprise:
a first quartz resonator operable to detect a pressure associated with the environment, the first quartz resonator comprising a pressure crystal having a mechanical resonant frequency response that is a strong function of pressure and a weak function of temperature;
a second quartz resonator operable to detect a temperature associated with the environment, the second quartz resonator comprising a temperature crystal having a mechanical resonant frequency response that is a strong function of temperature and a weak function of pressure; and
a third quartz resonator operable to detect a chemical species associated with the environment, the third quartz resonator comprising a chemical crystal that comprises a chemical coating operable to absorb a particular chemical species and to change the mass of the chemical crystal.

17. A method of using at least a portion of optical power of an optical signal to detect a parameter of an environment, the method comprising:
converting at least a portion of an optical power of an optical signal received by a sensor to electrical power;
using at least a portion of the electrical power to detect one or more state properties of an environment;
generating one or more sensing signals in response to the detected one or more state properties of the environment;
manipulating one or more optical characteristics of the optical signal based at least in part on the sensing signal; and
communicating at least a portion of the manipulated optical signal from the sensor.

18. The method of claim 17, wherein using at least a portion of the electrical power to detect one or more state properties of an environment, comprises:
conveying at least a first portion of the electrical power to a first quartz resonator operable to detect a pressure associated with the environment, the first quartz resonator comprising a pressure crystal having a mechanical resonant frequency response that is a strong function of pressure and a weak function of temperature;
conveying at least a second portion of the electrical power to a second quartz resonator operable to detect a temperature associated with the environment, the second quartz resonator comprising a temperature crystal having a mechanical resonant frequency response that is a strong function of temperature and a weak function of pressure; and
conveying at least a third portion of the electrical power to a third quartz resonator operable to detect a chemical species associated with the environment, the third quartz resonator comprising a chemical crystal that comprises a chemical coating operable to absorb a particular chemical species and to change the mass of the chemical crystal.

19. The method of claim 17, wherein manipulating one or more optical characteristics of the optical signal based at least in part on the sensing signal comprises:
generating an oscillation frequency based at least in part on the sensing signals; and
changing a reflective property of an optical device based at least in part on the oscillation frequency generated by the oscillator circuit.

20. The method of claim 19, wherein changing a reflective property of an optical device comprises moving a moveable mirror element relative to a stationary mirror element based at least in part on the oscillation frequency generated by the oscillator circuit, the moveable mirror element moving relative to the stationary mirror element in response to an electrostatic force, the electrostatic force generated using at least another portion of the electrical power, wherein a space between the moveable mirror element and the stationary mirror element operates to define an optical cavity and wherein a change in a depth of the optical cavity operates to change the reflective property.
